(19) United States
(12) Patent Application Publication
(10) Pub. No.: US 2016/0337422 A1
(43) Pub. Date: Nov. 17, 2016

(54) METHOD AND SYSTEM FOR TRANSMITTING REMOTELY GROUPCAST MESSAGE AND STORAGE MEDIUM ACCESSIBLE BY ELECTRONIC DEVICES

(71) Applicant: GEMTEK TECHNOLOGY CO., LTD., HSINCHU (TW)

(72) Inventors: CHUNG-CHIU LAI, HSINCHU (TW); CHIA-MENG CHEN, HSINCHU (TW)

(21) Appl. No.: 14/929,594

(22) Filed: Nov. 2, 2015

(30) Foreign Application Priority Data
May 13, 2015 (CN) 201510242127.9
Sep. 14, 2015 (CN) 201510581690.9

(51) Int. Cl. H04L 29/06; H04W 8/24

(52) U.S. Cl. CPC H04L 65/4076; H04W 8/24

(57) ABSTRACT

The present invention relates to a method and system for transmitting remotely a groupcast message and a storage medium accessible by electronic devices applicable to a first electronic device transmitting a groupcast message to at least a remote second electronic device. The method comprises steps of: setting a plurality of second electronic devices to at least a group; setting one of the plurality of second electronic devices in the group as a remote transceiver; the first electronic device transmitting the groupcast message to the remote transceiver; and the remote transceiver transmitting a broadcast message to the plurality of second electronic devices in the group. Thereby, transmission of a groupcast message to the second electronic devices can be ensured without adding extra transmission cost.

### FIELD OF THE INVENTION

The present invention relates generally to communication, and particularly to a transmission method and system for groupcast message to at least a remote electronic device, and to a storage medium accessible by electronic devices.

### BACKGROUND OF THE INVENTION

As the Internet is developing rapidly, the technology of Internet of Things (IoT) attracts attention increasingly and is applied to various fields in people's everyday lives.

The IoT is a network based the Internet and enabling physical entities therein having networking capability to communicate with one another. In the IoT, each physical entity can be accessed or manipulated through the network. Equipment, machines, and articles can be managed and manipulated concentrically via the IoT. Its application range is very extensive, such as smart living environment, health and medical, and burglarproof applications.

The methods for manipulating physical entities in the IoT can be categorized into two types. The first is to command the physical entities to be manipulated directly. If the client commands a physical entity inside the IoT, direct manipulation is an easily achievable method. Nonetheless, as the client is at a remote site and wishes to manipulate the physical entity in the IoT, the manipulation command needs to be delivered via the network media. If the physical entity is disposed nearby the network media, the manipulation command submitted by the client can certainly be delivered smoothly. Unfortunately, if the physical entity is disposed so remote to the network media that the manipulation command cannot be delivered via the network media, the second type of method should be adopted for delivering the manipulation command.

The second type of method for manipulating physical entities in the IoT is to transmit groupcast messages containing manipulation command to all the physical entities in the IoT. This transmission method is that the client uses an electronic device, for example, a mobile phone, to transmit remotely groupcast messages to physical entities in the IoT.

Nonetheless, current methods of transmitting remotely groupcast messages to physical entities in the IoT for manipulating physical objects are relatively complicated. Using these methods according to the prior art sometimes induces extra transmission costs and system complexity. Accordingly, how to transmit a groupcast message to a physical entity in the IoT with certainty without increasing extra transmission costs and system complexity has become a major subject in the present day.

### SUMMARY

An objective of the present invention is to provide a method and system for transmitting remotely a groupcast message and a storage medium accessible by electronic devices, which can transmit groupcast messages to remote electronic devices without increasing extra transmission costs and system complexity.

In order to achieve the objectives and efficacies as described above, an embodiment according to the present invention discloses a method for transmitting remotely a groupcast message applicable to a first electronic device transmitting a groupcast message to at least a remote second electronic device. The method comprises steps of: setting a plurality of second electronic devices to at least a group; setting one of the plurality of second electronic devices in the group as a remote transceiver; the first electronic device transmitting the groupcast message to the remote transceiver; and the remote transceiver transmitting a broadcast message to the plurality of second electronic devices in the group.

Furthermore, according to another embodiment of the present invention, a system for transmitting remotely a groupcast message is disclosed and applicable to transmitting remotely a groupcast message to at least a second electronic device. The system comprises a first electronic device and a plurality of second electronic devices. The first electronic device transmits a groupcast message. The plurality of second electronic devices are grouped to at least a group. One of the plurality of second electronic devices in the group is set as a remote transceiver. The first electronic device transmits the groupcast message to the remote transceiver. The remote transceiver transmits a broadcast message to the plurality of second electronic devices in the group.

Moreover, according another embodiment of the present invention, a storage medium accessible by electronic devices is disclosed. A program is stored in the storage medium accessible by electronic devices and used for executing a method for transmitting remotely a groupcast message. The method is applicable to a first electronic device transmitting remotely a groupcast message to at least a second electronic device. The method comprises steps of: setting a plurality of second electronic devices to at least a group: setting one of the plurality of second electronic devices in the group as a remote transceiver; the first electronic device transmitting the groupcast message to the remote transceiver; and the remote transceiver transmitting a broadcast message to the plurality of second electronic devices in the group.

### BRIEF DESCRIPTION OF THE DRAWINGS

FIG. 1A and FIG. 1B show schematic diagrams of the system for transmitting remotely a groupcast message according to the first embodiment of the present invention;

FIG. 2 shows a flowchart of the method for transmitting remotely a groupcast message according to the first embodiment of the present invention;

FIG. 3 shows a schematic diagram of grouping according to an embodiment of the present invention;

FIGS. 4A to 4E show schematic diagrams of the system for transmitting remotely a groupcast message according to the second embodiment of the present invention; and

FIG. 5 shows a flowchart of the method for transmitting remotely a groupcast message according to the second embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

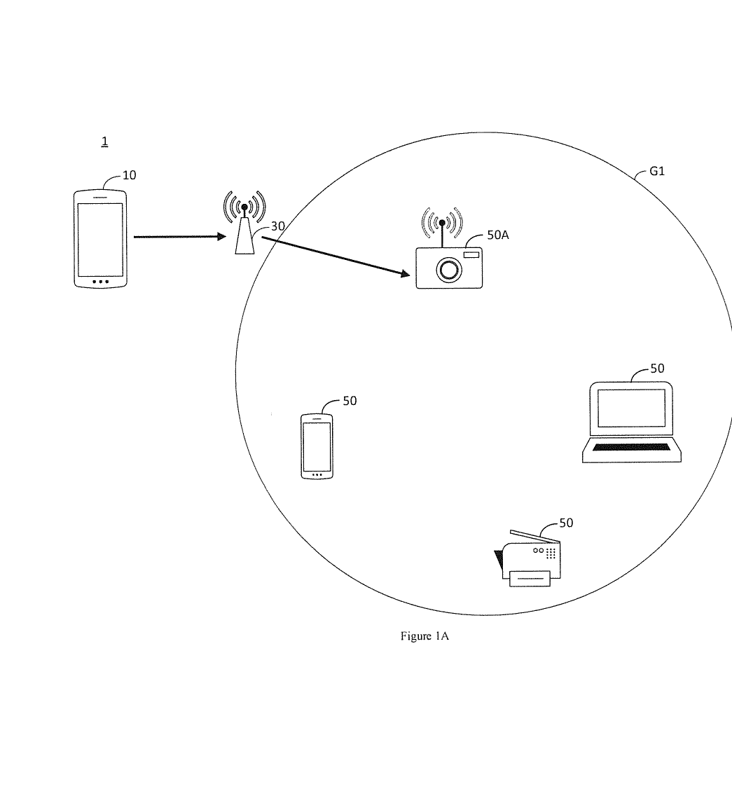

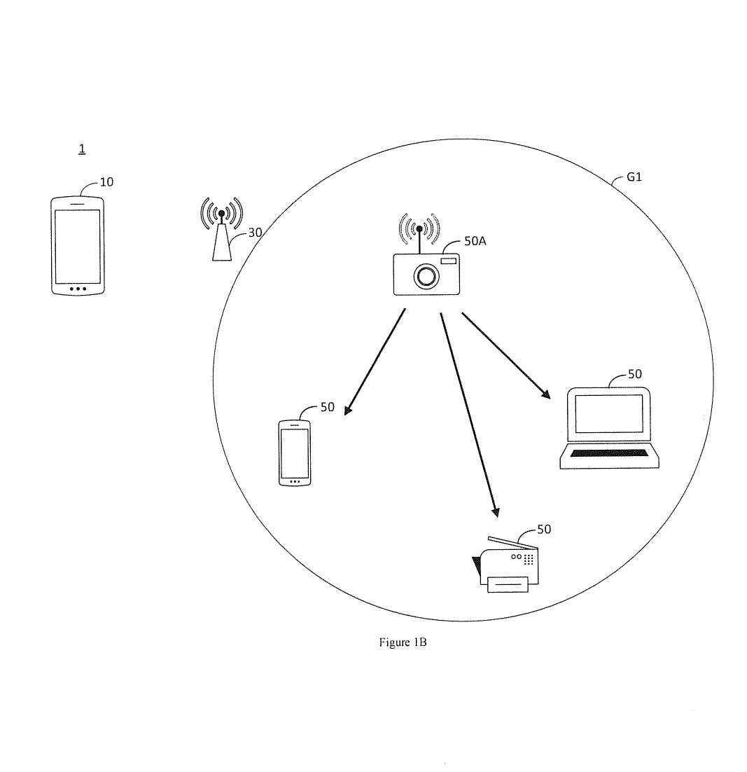

Please refer to FIG. 1A. As shown in the figure, the present embodiment provides a system 1 for transmitting remotely a groupcast message, which comprises a first electronic device 10, a medium 30, and a plurality of second electronic devices 50. According to the present embodiment, the first electronic device 10 and the plurality of second electronic devices 50 transmit information via the medium 30.

The first electronic device 10 according to the present embodiment includes a smartphone, a personal digital assistant (PDA), a tablet computer, a notebook computer, a desktop computer, or other electronic devices capable of transmitting information.

The plurality of second electronic devices 50 according to the present invention include smartphones, PDAs, tablet computers, notebook computers, desktop computers, webcams, smart plugs, or other electronic devices capable of transmitting information. In addition, each of the plurality of second electronic devices 50 includes a connecting unit, respectively and is capable of connecting to one another through the respective connecting unit. The connecting unit includes infrared, Bluetooth, ZigBee, Wi-Fi, or physical networks.

The medium 30 according to the present embodiment includes a router, a switch, a hub, a cloud server, a relay, or other media capable of network transmission.

The system 1 according to the present embodiment is used for transmitting a groupcast message to at least a second electronic device 50 by the first electronic device 10 for controlling or configuring the plurality of second electronic devices 50 in the group or transmitting data to the plurality of second electronic devices 50 in the group. For example, the first electronic device 10 according to the present embodiment is a smartphone while the plurality of second electronic devices 50 are smart appliances. When a user operates the first electronic device 10 and transmits a control signal to the plurality of second electronic devices 50, the signal can be transmitted using the method and system 1 for transmitting a groupcast message disclosed in the present embodiment.

Please refer to FIG. 1A, 1B, and 2. As shown in the figures, when the transmission system 1 according to the present embodiment operates, the step ST1 is first executed for setting the plurality of second electronic device 50 as at least one group. As shown in FIG. 1A and according to the present embodiment, the first electronic device 10 groups the plurality of second electronic devices 50 to the same group G1. Nonetheless, the present invention is not limited to the embodiment. Alternatively, the plurality of second electronic devices 50 can be set to the same group G1 prior to delivery. Furthermore, the plurality of second electronic devices 50 can be set by the user to the same group G1 while installing or at another moment. The method for grouping includes setting the plurality of second electronic devices 50 having the same properties, for example, all being computers, to the same group, setting the plurality of second electronic devices 50 capable of executing the same actions, for example, lights, air conditioners, and fans, all executing turning on or off actions, to the same group, setting the plurality of second electronic devices 50 dependent on one another, for example, computers and printers, which should be turned on for printing documents, to the same group, or setting groups according to the user's requirements.

After the step ST1 is finished, the step ST3 is executed for setting one of the plurality of second electronic devices 50 in the group G1 as a remote transceiver 50A. As shown in FIG. 1A, according to the present embodiment, a second electronic device 50 in the group G1 is assigned as the remote transceiver 50A.

According to an embodiment of the present invention, when the step ST1 is executed, the step ST3 will be executed concurrently. In other words, when the group G1 is set, the remote transceiver 50A will be set at the same time. Then the preparation process before the first electronic device 10 can transmit the groupcast message is finished. Afterwards, when the first electronic device 10 transmits the groupcast message, it is no more required to ser the remote transceiver 50A. Instead, the first electronic device 10 can transmit directly the groupcast message to the configured remote transceiver 50A.

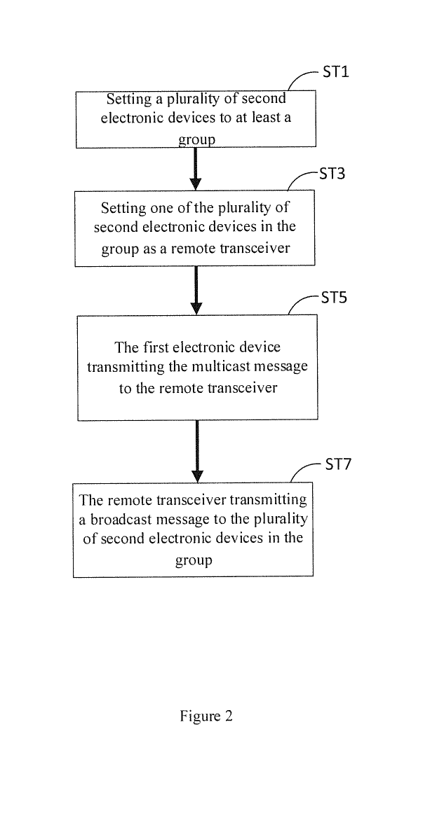

Please refer again to FIG. 2. The step ST5 is executed, in which the first electronic device 10 transmits the groupcast message to the remote transceiver 50A.

As shown in FIG. 1A, the first electronic device 10 transmits the groupcast message to the remote transceiver 50A via the medium 30. The remote transceiver 50A receives the groupcast message. The groupcast message described above includes the control signal to be transmitted by the first electronic device 10. According to an embodiment of the present invention, the first electronic device 10 transmits the groupcast message to the remote transceiver 50A via the TCP or UDP.

Please refer again to FIG. 2. Finally, the step ST7 is executed, in which the remote transceiver 50A transmits a broadcast message according to the received groupcast message to the plurality of second electronic devices 50, as shown in FIG. 1B. That is to say, the broadcast message will be transmitted to all of the plurality of second electronic devices 50 in the group G1. The content of the broadcast message includes the groupcast message, namely, the control signal transmitted by the first electronic device 10. According to the above, the present embodiment provides a method and system for transmitting remotely a groupcast message. While setting the group G1, one of the second electronic devices 50 in the group G1 is further assigned as the remote transceiver 50A. When the first electronic device 10 needs to control the plurality of second electronic devices 50 in the group G1, the remote transceiver 50A can be used to connect with the plurality of second electronic devices 50 in the group G1.

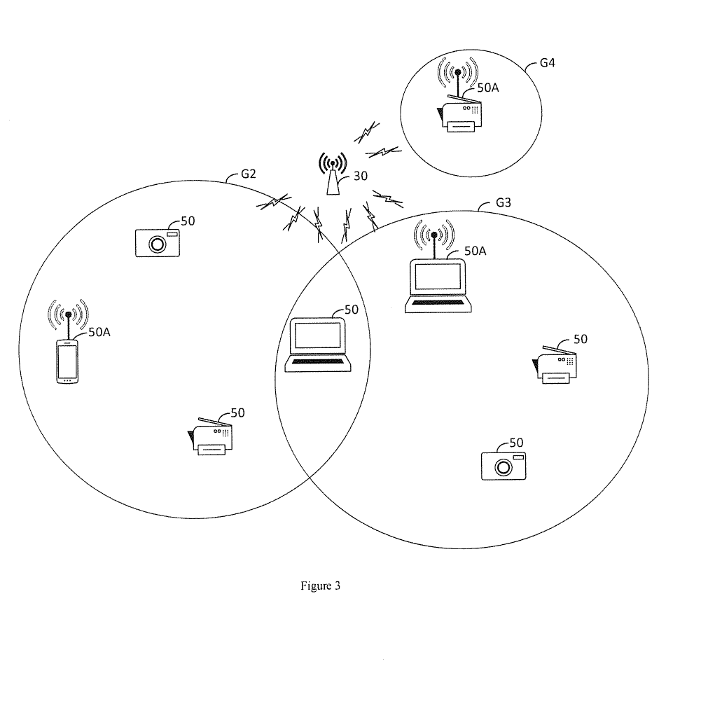

According to another embodiment of the present invention, the plurality of second electronic devices 50 can be defined into multiple groups. As shown in FIG. 3, each group includes at least a second electronic device 50. The second electronic devices 50 in the same group can transmit information to one another; the second electronic devices 50 in different groups can transmit information to one another as well. The first electronic device 10 can transmit a groupcast message to a group or a plurality of groups. As shown in FIG. 3, the group G2 and the group G3 are groups including a plurality of second electronic devices 50. The group G4, on the other hand, is a group including only a single second electronic device 50. In addition, only one second electronic device 50 in the groups G2˜G4 is assigned as the remote transceiver 50A.

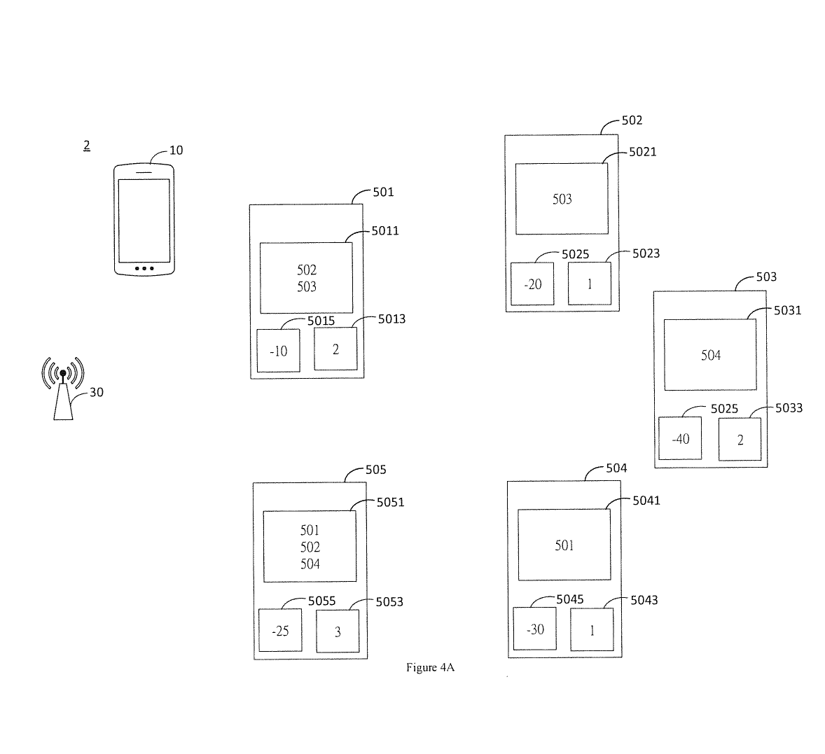

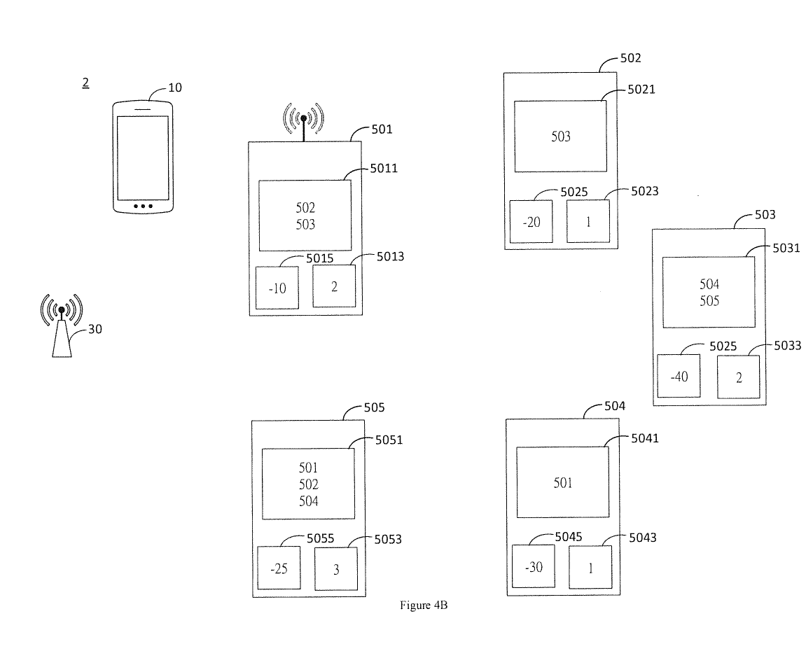

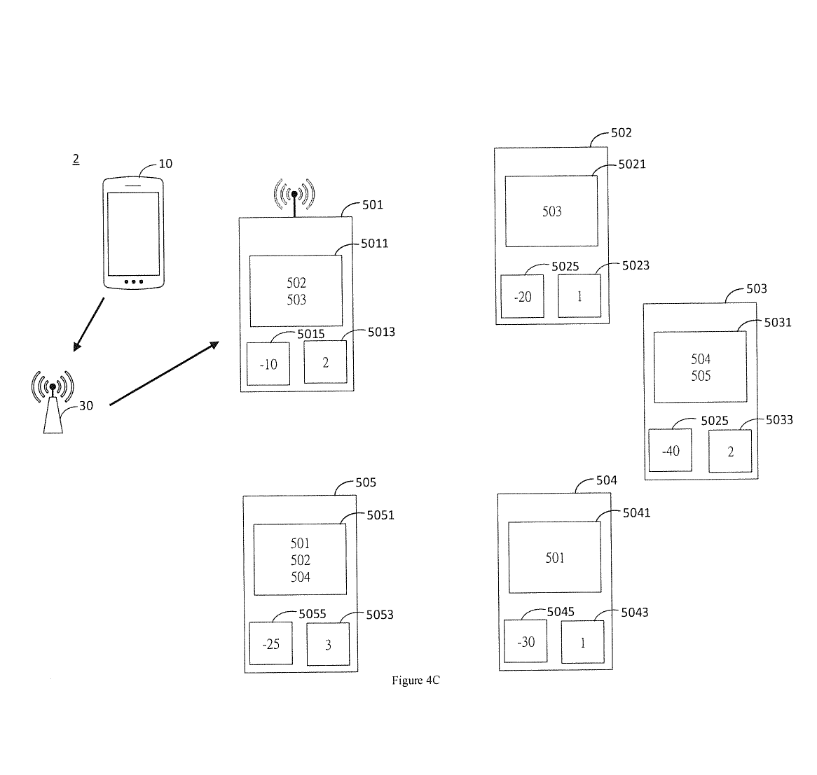

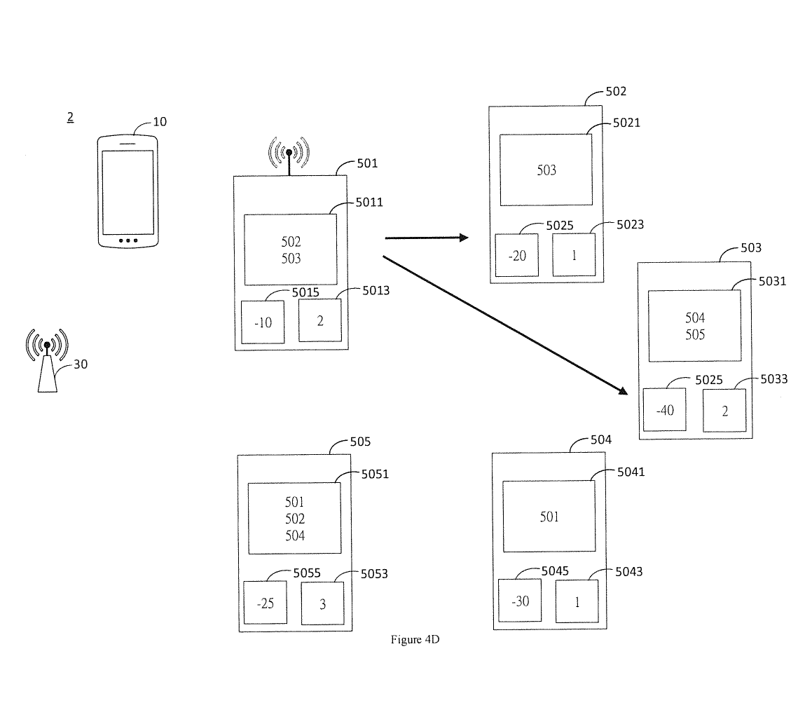

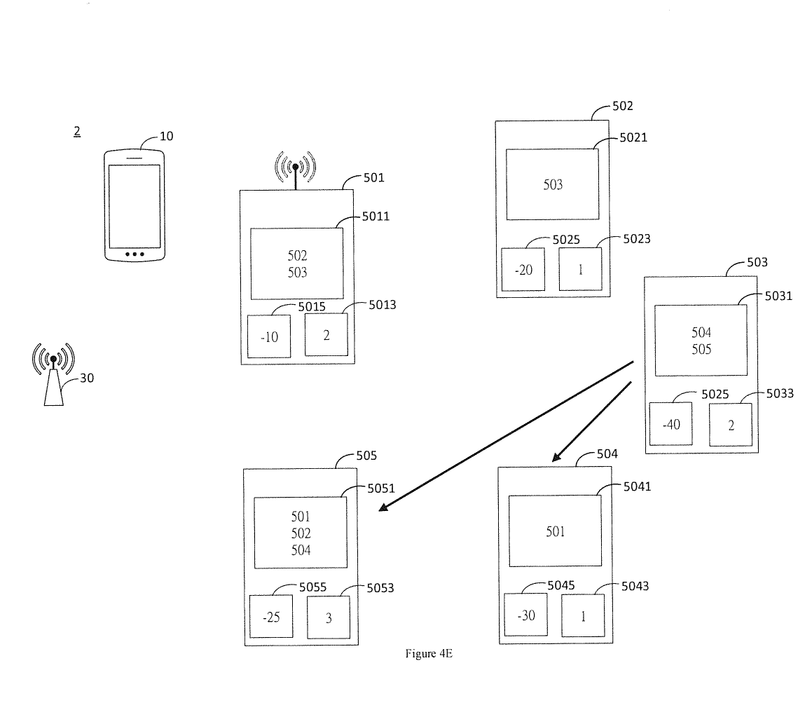

Next, the system for transmitting remotely a groupcast message according to another embodiment will be described. Please refer to FIG. 4A. As shown in the figure, the embodiment provides another system 2 for transmitting remotely a groupcast message. The system 2 comprises a first electronic device 10, a medium 30, and a plurality of second electronic devices 501, 502, 503, 504, 505. According to the present embodiment, the second electronic device 501 includes a neighborhood table 5011, a neighborhood quantity 5013, and a piece of communication quality information 5015. The neighborhood table 5011 records the other second electronic devices nearby the second electronic device 501. The neighborhood quantity represents the quantity of the other second electronic devices nearby the second electronic device 501.

The communication quality information as described above represents the connection quality between each second electronic device 50 and nearby devices, which include the other second electronic devices 502, 503 and the medium 30. Thereby, the communication quality information of the second electronic device 501 includes the received signal strength indicator (RSSI) or the signal to noise ratio (SNR), representing the transmission intensity of the second electronic device 501.

Please refer again to FIG. 4A. The second electronic device 502 includes a neighborhood table 5021, a neighborhood quantity 5023, and a piece of communication quality information 5025. The neighborhood table 5021 records the other second electronic devices nearby the second electronic device 502. The neighborhood quantity 5023 represents the quantity of the other second electronic devices nearby the second electronic device 502. The communication quality information 5025 is the connection quality between the second electronic devices 502 the nearby other electronic devices and includes the communication quality between the second electronic device 502 and the medium 30. As the above description, the rest second electronic devices 503, 504, 505 also include neighborhood tables 5031, 5041, 5051, neighborhood quantities 5033, 5043, 5053, and communication quality information 5035, 5045, 5055. Each of the above second electronic devices 501, 502, 503, 504, 505 searches the nearby devices at startup, records the search result in the respective neighborhood table 5011, 5012, 5031, 5041, 5051, and records the quantities of nearby devices. Besides, according an embodiment of the present invention, the nearby devices that each of the above second electronic devices 501, 502, 503, 504, 505 searches at startup include the medium 30.

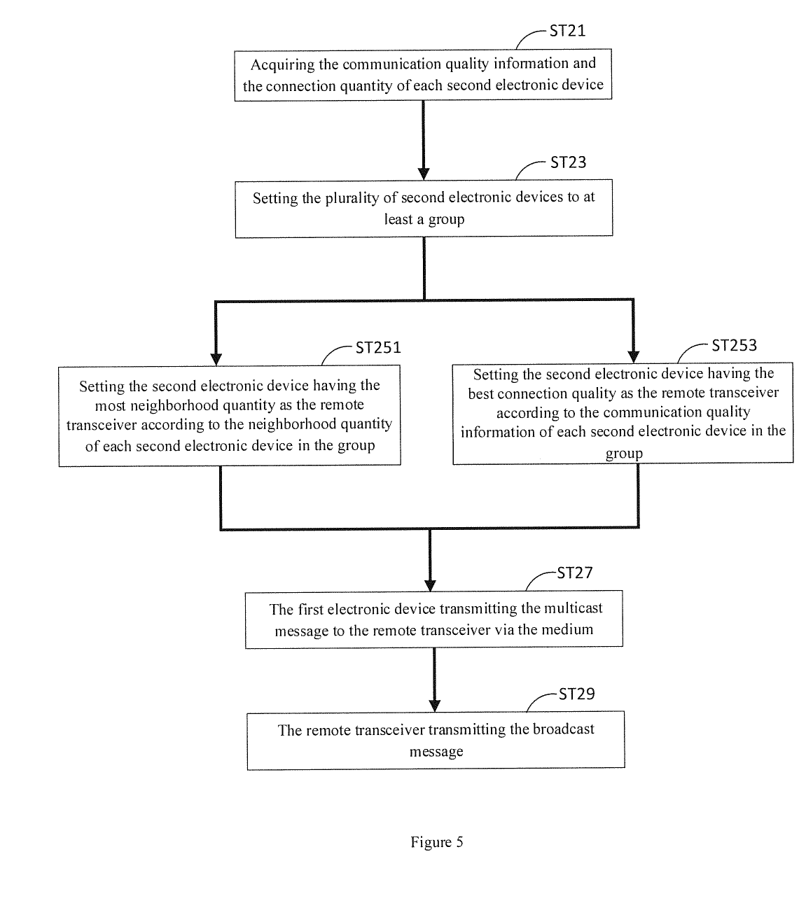

Please refer to FIG. 5 as well as FIGS. 4A to 4E. When the system 2 according to the present embodiment is operating, the step ST21 is first executed, in which the first electronic device 10 acquires respective communication quality information 5015-5055 and neighborhood quantities 5013-5053 of each of the second electronic devices 501, 502, 503, 504, 505. Then the step ST23 is executed for defining the plurality of second electronic devices 501, 502, 503, 504, 505 to at least one group. According to the present embodiment, the plurality of second electronic devices 501, 502, 503, 504, 505 belong to one group. In this step, the plurality of second electronic devices 501-505 may have no neighborhood quantity, for example, when the second electronic device is placed at remote places such as the balcony or the roof. This means that this second electronic device cannot transmit information with the other electronic devices. In order to make sure that the control signal or information can be transmitted to each second electronic device, the second electronic device having no neighborhood quantity is set to a group. The purpose is that when the neighborhood quantity of the second electronic device is zero, it means that the second electronic device cannot connected with any other second electronic device. If the second electronic device does not form a group independently, it cannot receive the messages transmitted from the first electronic device 10. As the second electronic device is set to a group, the first electronic device 10 can transmit the groupcast message directly to the second electronic device. Thereby, it is ensured that the second electronic device can receive the control signal or information of the first electronic device 10.

Next, the step ST251 or ST253 is executed. When the step ST251 is executed and the first electronic device 10 sets one of the plurality of second electronic devices in the group as the remote transceiver, the communication quality information 5015-5055 of the second electronic devices 501-505 collected in the step ST21 is used as a reference. The method by which the first electronic device 10 selects the remote transceiver is based on the respective communication quality information of each of the second electronic devices 501, 502, 503, 504, 505. The one having the best connection quality is selected as the remote transceiver. According to the present embodiment, the communication quality information 5015˜5055 of the plurality of second electronic devices 501˜505 is the RSSI having the values −10 dBm, −20 dBm, −40 dBm, −30 dBm, −25 dBm, respectively. In the step ST253, the neighborhood quantities 5013˜5053 of the second electronic devices 501˜505 collected in the step ST21 are used as a reference. The second electronic device having the most neighborhood quantity is selected as the remote transceiver. According to the present embodiment, the plurality of neighborhood quantities 5013˜5053 of the plurality of second electronic devices 501˜505 are 2, 1, 2, 1, and 3, respectively.

If the present embodiment executes the step ST251, then the second electronic device 501 owns the best connection quality. Consequently, the second electronic device 501 is set as the remote transceiver. On the other hand, if the present embodiment executes the step ST253, then the neighborhood quantity of the second electronic device 505 is the most, meaning that the second electronic device 505 has the most nearby second electronic devices. Then, the second electronic device 505 is assigned as the remote transceiver. According to the present embodiment, the step ST251 is executed. As shown in FIG. 4B, the second electronic device 501 is selected as the remote transceiver. In the situation of having multiple groups, the first electronic device 10 can choose to execute the step ST251 or ST253, respectively, for determining the remote transceiver of each group. That is to say, different groups can set the remote transceiver in the groups according to the communication quality information or the neighborhood quantity.

Please refer to FIG. 5. Next, the step ST27 is executed. As shown in FIG. 4C, the first electronic device 10 transmits the groupcast message to the second electronic device 501 via the medium 30. The second electronic device 501 receives the groupcast message. Afterwards, the step ST29 is executed, in which the second electronic device 501 (the remote transceiver) transmits a broadcast message according to the groupcast message. The content of the broadcast message includes the content of the groupcast message and the neighborhood table of the remote transceiver. In other words, the broadcast message transmitted by the second electronic device 501 includes the content of the groupcast message and the neighborhood table 5011. The second electronic device 501 transmits the broadcast message according to the neighborhood table 5011. As shown in FIG. 4D, the second electronic device 501 transmits the broadcast message to the second electronic device 502 and the second electronic device 503 according to the neighborhood table 5011.

Moreover, the plurality of second electronic devices having received the broadcast message will compare their own neighborhood tables with that of the remote transceiver. When their own neighborhood tables include the second electronic device not recorded in the neighborhood tables of the remote transceiver, they will transmit the received broadcast message according to their own neighborhood tables. As shown in FIG. 4E, when the plurality of second electronic device 502, 503 receive the broadcast messages transmitted by the second electronic device 501 (the remote transceiver), the plurality of second electronic devices 502, 503 compares the neighborhood table 5011 in the broadcast messages. According to the present embodiment, the neighborhood table 5011 does not include the second electronic devices 504, 505 recorded in the neighborhood table 5031 of the second electronic device 503. Thereby, as shown in FIG. 4E, the second electronic device 503 transmits the received broadcast message to the plurality of second electronic devices 504, 505 according to its own neighborhood table 5031, and thus ensuring that the broadcast message can be transmitted to all second electronic devices. Namely, it is ensured that all second electronic devices in the group can receive the control signal or information transmitted by the first electronic device 10.

The transmission method for groupcast message according to the present invention can be implemented as a program and stored in a storage medium accessible by an electronic device. Thereby, after the electronic device reads the storage medium, the transmission method for groupcast message is executed. A computer accessible storage medium can be a read-only memory, a flash memory, a floppy disk. A hard disk, a compact disk, a USB flash drive, a magnetic tape, a network accessible database, or any other storage medium accessible by electronic devices well known to a personal having ordinary skill in the art.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is

1. A method for transmitting remotely a groupcast message, applicable to a first electronic device transmitting a groupcast message to at least a remote second electronic device, comprising steps of:
setting a plurality of second electronic devices to at least a group;
setting one of said plurality of second electronic devices in said group as a remote transceiver;
said first electronic device transmitting said groupcast message to said remote transceiver; and
said remote transceiver transmitting a broadcast message to said plurality of second electronic devices in said group.

2. The method for transmitting remotely a groupcast message of claim 1, wherein only a single second electronic device is set as said remote transceiver.

3. The method for transmitting remotely a groupcast message of claim 1, wherein each of said second electronic devices includes a neighborhood table, respectively, recording nearby other second electronic devices of said second electronic device; said broadcast message transmitted by said remote transceiver includes said neighborhood table of said remote transceiver; after said second electronic device receives said broadcast message transmitted by said remote transceiver, said second electronic device compares its own neighborhood table with said neighborhood table of said remote transceiver; and when its own neighborhood table includes the second electronic device not recorded in said neighborhood table of said remote transceiver, said second electronic device transmits said received broadcast message according to its own neighborhood table.

4. The method for transmitting remotely a groupcast message of claim 3, and further comprising a step of each of said second electronic devices searching nearby other second electronic devices and recording in said neighborhood table.

5. The method for transmitting remotely a groupcast message of claim 1, wherein each of said second electronic devices records the neighborhood quantity of the nearby second electronic devices of said second electronic device, respectively, so that said second electronic device having zero neighborhood quantity can be set as a group.

6. The method for transmitting remotely a groupcast message of claim 1, wherein each of said second electronic devices records the neighborhood quantity of the nearby second electronic devices of said second electronic device, respectively; and said second electronic device having the most neighborhood quantity is set as said remote transceiver.

7. The method for transmitting remotely a groupcast message of claim 1, and further comprising a step of acquiring the communication quality information of each of said second electronic devices, each piece of said communication quality information representing the connection quality between each second electronic device and the neighboring devices, and setting said second electronic device having the best connection quality in said group as said remote transceiver.

8. The method for transmitting remotely a groupcast message of claim 1, wherein said first electronic device and said plurality of second electronic devices transmit information via a medium.

9. A system for transmitting remotely a groupcast message, applicable to transmitting a groupcast message to at least a remote second electronic device, comprising:
a first electronic device, transmitting said groupcast message; and
a plurality of second electronic devices, set to at least a group, and one of said plurality of second electronic devices set as a remote transceiver;
where said first electronic device transmits said groupcast message to said remote transceiver, and said remote transceiver transmits a broadcast message to said plurality of second electronic devices in said group.

10. The system for transmitting remotely a groupcast message of claim 9, wherein only a single second electronic device is set as said remote transceiver.

11. The system for transmitting remotely a groupcast message of claim 9, wherein each of said second electronic devices includes a neighborhood table, respectively, recording nearby other second electronic devices of said second electronic device; said broadcast message transmitted by said remote transceiver includes said neighborhood table of said remote transceiver; after said second electronic device receives said broadcast message transmitted by said remote transceiver, said second electronic device compares its own neighborhood table with the neighborhood table of said remote transceiver; and when its own neighborhood table includes the second electronic device not recorded in said neighborhood table of said remote transceiver, said second electronic device transmits said received broadcast message according to its own neighborhood table.

12. The system for transmitting remotely a groupcast message of claim 11, and further comprising a step of each of said second electronic devices searching nearby other second electronic devices and recording in said neighborhood table.

13. The system for transmitting remotely a groupcast message of claim 9, wherein each of said second electronic devices records the neighborhood quantity of the nearby second electronic devices of said second electronic device, respectively, so that said second electronic device having zero neighborhood quantity can be set as a group.

14. The system for transmitting remotely a groupcast message of claim 9, wherein each of said second electronic devices records the neighborhood quantity of the nearby second electronic devices of said second electronic device, respectively; and said second electronic device having the most neighborhood quantity is set as said remote transceiver.

15. The system for transmitting remotely a groupcast message of claim 9, and further comprising a step of acquiring the communication quality information of each of said second electronic devices, each piece of said communication quality information representing the connection quality between each second electronic device and the neighboring devices, and setting said second electronic device having the best connection quality in said group as said remote transceiver.

16. The system for transmitting remotely a groupcast message of claim 9, wherein said first electronic device and said plurality of second electronic devices transmit information via a medium.

17. A storage medium accessible by electronic devices, storing a program, used for executing a method for transmitting remotely a groupcast message applicable to a first electronic device transmitting a groupcast message to at least a remote second electronic device, and said method comprising steps of:
setting a plurality of second electronic devices to at least a group;
setting one of said plurality of second electronic devices in said group as a remote transceiver;
said first electronic device transmitting said groupcast message to said remote transceiver; and
said remote transceiver transmitting a broadcast message to said plurality of second electronic devices in said group.

18. The storage medium accessible by electronic devices of claim 17, wherein only a single second electronic device is set as said remote transceiver.

19. The storage medium accessible by electronic devices of claim 17, wherein each of said second electronic devices includes a neighborhood table, respectively, recording nearby other second electronic devices of said second electronic device; said broadcast message transmitted by said remote transceiver includes said neighborhood table of said remote transceiver; after said second electronic device receives said broadcast message transmitted by said remote transceiver, said second electronic device compares its own neighborhood table with the neighborhood table of said remote transceiver; and when its own neighborhood table includes the second electronic device not recorded in said neighborhood table of said remote transceiver, said second electronic device transmits said received broadcast message according to its own neighborhood table.

20. The storage medium accessible by electronic devices of claim 19, and further comprising a step of each of said second electronic devices searching nearby other second electronic devices and recording in said neighborhood table.

21. The storage medium accessible by electronic devices of claim 17, wherein each of said second electronic devices records the neighborhood quantity of the nearby second electronic devices of said second electronic device, respectively, and said second electronic device having zero neighborhood quantity is set as another group.

22. The storage medium accessible by electronic devices of claim 17, wherein each of said second electronic devices records the neighborhood quantity of the nearby second electronic devices of said second electronic device, respectively; and said second electronic device having the most neighborhood quantity is set as said remote transceiver.

23. The storage medium accessible by electronic devices of claim 17, and further comprising a step of acquiring the communication quality information of each of said second electronic devices, each piece of said communication quality information representing the connection quality between each second electronic device and the neighboring devices, and setting said second electronic device having the best connection quality in said group as said remote transceiver.

24. The storage medium accessible by electronic devices of claim 17, wherein said first electronic device and said plurality of second electronic devices transmit information via a medium.
